(19) United States
(12) Patent Application Publication
(10) Pub. No.: US 2026/0340294 A1
(43) Pub. Date: Oct. 29, 2026

(54) SEMANTIC IDENTIFIER GENERATION METHOD, SEMANTIC IDENTIFIER GENERATION APPARATUS AND NON-TRANSITORY COMPUTER-READABLE STORAGE MEDIUM

(71) Applicants: China Mobile Communication Co., Ltd Research Institute, BEIJING (CN); CHINA MOBILE COMMUNICATIONS GROUP CO., LTD., BEIJING (CN)

(72) Inventors: Shujuan YOU, BEIJING (CN); Xiaotao LI, BEIJING (CN)

(73) Assignees: China Mobile Communication Co., Ltd Research Institute, BEIJING (CN); CHINA MOBILE COMMUNICATIONS GROUP CO., LTD., BEIJING (CN)

(21) Appl. No.: 19/703,082

(22) Filed: Jun. 10, 2026

Related U.S. Application Data
(63) Continuation of application No. PCT/CN2024/140050, filed on Dec. 17, 2024.

(30) Foreign Application Priority Data
Dec. 26, 2023 (CN) 202311810679.6

(51) Int. Cl. G06F 40/30; G06F 40/205

(52) U.S. Cl. CPC G06F 40/30; G06F 40/205

(57) ABSTRACT

The embodiments of the present disclosure provide a semantic identifier generation method, a semantic identifier generation apparatus, and a non-transitory computer-readable storage medium. The method comprises: obtaining an identifier; determining an identification framework code of the identifier; parsing the identifier based on the identification framework code and obtaining an ontology prefix code; and determining a semantic identifier based on the ontology prefix code, the identification framework code, and the identifier.

### CROSS-REFERENCE TO RELATED APPLICATIONS

The present disclosure is a continuation of International Patent Application No. PCT/CN2024/140050, filed on Dec. 17, 2024, which claims foreign priority to Chinese Patent Application No. 202311810679.6, filed on Dec. 26, 2023, both of which are herein incorporated by reference in their entireties.

### TECHNICAL FIELD

The present disclosure relates to the field of the Internet of Things, and in particular to a semantic identifier generation method, a semantic identifier generation apparatus, and a non-transitory computer-readable storage medium.

### BACKGROUND

In the Internet of Things (IoT), each object requires a unique identifier as a digital identity to help users obtain detailed information of the object. Thousands of IoT identifiers coexist in the IoT ecosystem, such as a European article number (EAN), a digital object unique identifier (DOI), and a globe standard 1 (GS1), etc. These identifier schemes differ in a length, a value range, and a structure. IoT objects can hardly independently recognize the identification frameworks of other objects and obtain detailed information thereof.

Currently, the industrial circles have designed a series of compatible identifications to accommodate heterogeneous identifiers and perform unified parsing. These heterogeneous identifiers include an object identifier (OID) and a Handle, unified parsing of these heterogeneous identifiers in different forms can be achieved via these compatible identifications. However, these compatible identifications in the related art are not automatically generated, users of original identifiers are required to manually register the original identifiers into a compatible identification system in advance based on standard rules defined for the compatible identifications. This reduces the intelligence of the IoT system. Moreover, these compatible identifications lack machine-understandable semantic information and cannot support intelligent interaction between different objects.

### SUMMARY

In a first aspect, a semantic identifier generation method is provided and includes: obtaining an identifier; determining an identification framework code of the identifier; parsing the identifier based on the identification framework code and obtaining an ontology prefix code; and determining a semantic identifier based on the ontology prefix code, the identification framework code, and the identifier.

In a second aspect, a semantic identifier generation apparatus is provided and includes a processor and a memory. The memory is configured to store a computer program executable on the processor; and the processor is configured to, when running the computer program, perform the above semantic identifier generation method.

In a third aspect, a non-transitory computer-readable storage medium is provided and store a computer program code. The computer program code, when executed by a computer, implements the above semantic identifier generation method.

### BRIEF DESCRIPTION OF THE DRAWINGS

FIG. 1 is a schematic diagram of a semantic identifier generation method according to some embodiments of the present disclosure.

FIG. 2 is a schematic diagram of character mapping according to some embodiments of the present disclosure.

FIG. 3 is a schematic diagram of obtaining a first image according to some embodiments of the present disclosure.

FIG. 4 is a structural schematic diagram of an ontology according to some embodiments of the present disclosure.

FIG. 5 is a structural schematic diagram of an ontology according to some embodiments of the present disclosure.

FIG. 6 is a structural schematic diagram of a semantic identifier according to some embodiments of the present disclosure.

FIG. 7 is a schematic diagram of the semantic identifier generation method according to some embodiments of the present disclosure.

FIG. 8 is a schematic diagram of a conversion strategy from an identification to a color image according to some embodiments of the present disclosure.

FIG. 9 is a structural schematic diagram of a semantic identifier generation apparatus according to some embodiments of the present disclosure.

FIG. 10 is a structural schematic diagram of a semantic identifier generation apparatus according to some embodiments of the present disclosure.

### DETAILED DESCRIPTION

The technical solutions in embodiments of the present disclosure will be clearly and completely described below in conjunction with the accompanying drawings in the embodiments of the present disclosure. It is to be understood that the embodiments described herein are merely used to explain the present disclosure, rather than to limit the present disclosure. In addition, it should be noted that, for the convenience of description, only the parts related to the present disclosure are shown in the accompanying drawings.

In the Internet of Things (IoT), each object requires a unique identifier as a digital identity to help users obtain detailed information of the object. However, thousands of IoT identifiers coexist in the IoT ecosystem, such as a European article number (EAN), a digital object unique identifier (DOI), and a globe standard 1 (GS1), etc. These identifier schemes differ in a length, a value range, and a structure. IoT objects can hardly independently recognize the identification frameworks of other objects and obtain detailed information thereof.

To solve this problem, the industrial circles have designed a series of compatible identifications to accommodate heterogeneous identifiers and perform unified parsing. These heterogeneous identifiers include an object identifier (OID) and a Handle, unified parsing of these heterogeneous identifiers in different forms can be achieved via these compatible identifications. However, these compatible identifications in the related art are not automatically generated, users of original identifiers are required to manually register the original identifiers into a compatible identification system in advance based on standard rules defined for the compatible identifications, because only they know which identification scheme the legacy identifiers belong to. However, in IoT scenarios, with the ever-increasing number of IoT objects, manually recognizing and parsing these identifiers is unrealistic, and this defect severely limits the intelligent capability of the compatible identification system. In addition, these compatible identifications lack machine-understandable semantic information and cannot support intelligent interaction between different objects.

At present, the generation method of compatible identifications still has the following disadvantages. (1) Traditional identifications are heterogeneous and cannot be uniformly parsed, thereby failing to support mutual recognition and interworking between devices. (2) A small number of compatible identifications can be compatible with some heterogeneous identifications, but their generation processes are all manual; by defining standards, users manually map original identifications to compatible identifications based on the standards, because only they know which identification scheme the legacy identifiers belong to, lacking the capability to automatically recognize heterogeneous identifications; with the ever-increasing number of IoT objects, manually recognizing and parsing these identifiers is unrealistic, wasting manpower and material resources, and reducing the degree of automation; moreover, these compatible identifications lack semantic information and cannot support the intelligent interaction of identified articles. (3) A semantic identification in the related art configured to be compatible with heterogeneous identifications has certain defects; first, there is a problem of information confusion and indistinguishability in the semantic prefix part of the identification structure; for example, it is impossible to accurately distinguish whether the identification 1101 represents the 101st entity in the first layer or the first entity in the 11th layer; second, this method requires manually recognizing the identification scheme of the legacy identifier, because only users who registered the identification knows which identification scheme the legacy identifier belongs to; moreover, this method requires manual acquisition of the semantic prefix, and does not involve a method for automatically acquiring the semantic prefix; therefore, this method cannot automatically generate a semantic identification; semantic identification can only be manually generated by users; however, in IoT scenarios, with the ever-increasing number of IoT objects, manually generating compatible identifications is unrealistic, and this defect severely limits the intelligent capability of compatible identification systems.

In order to solve the problems of poor intelligence of current IoT systems and the incapability to support intelligent interactive operability between different objects, the embodiments of the present disclosure provide a semantic identifier generation method, a semantic identifier generation apparatus, and a non-transitory computer-readable storage medium. The method includes: a semantic identifier generation apparatus obtaining an identifier; determining an identification framework code of the identifier; parsing the identifier based on the identification framework code and obtaining an ontology prefix code; and determining a semantic identifier based on the ontology prefix code, the identification framework code, and the identifier. That is, the semantic identifier generation apparatus can automatically obtain the identification framework code of the identifier, parse the identifier based on the identification framework code and obtain the ontology prefix code, determine the semantic identifier based on the ontology prefix code, the identification framework code, and the identifier. The entire process of generating the semantic identifier in the present disclosure does not require human participation, and the semantic identifier can be automatically generated, thereby improving the intelligence of the IoT system. Moreover, the ontology prefix code in the present disclosure can provide corresponding semantic information to support intelligent interaction between different objects.

The technical solutions in the embodiments of the present disclosure will be clearly and completely described below in conjunction with the accompanying drawings in the embodiments of the present disclosure.

### Embodiment 1

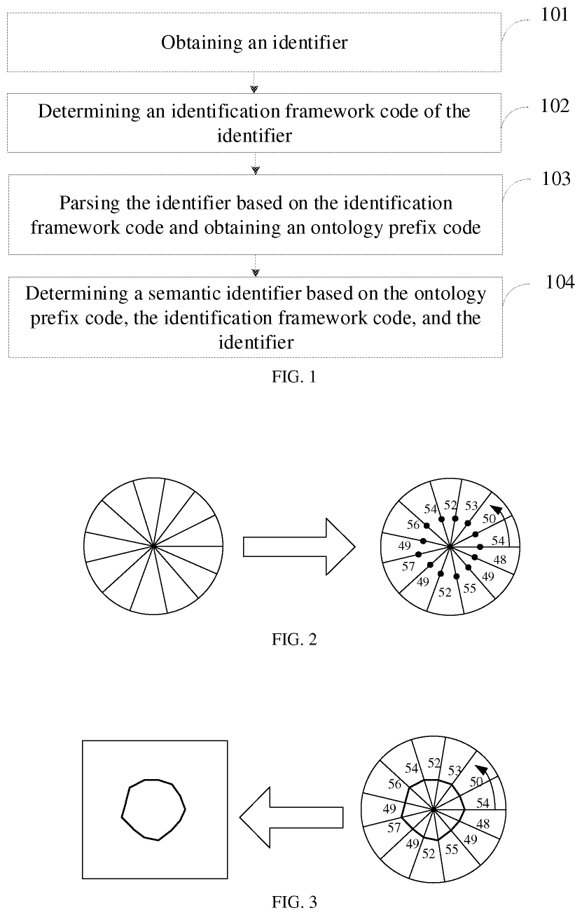

Some embodiments of the present disclosure provide a semantic identifier generation method. FIG. 1 is a schematic diagram of a semantic identifier generation method according to some embodiments of the present disclosure. As shown in FIG. 1, the semantic identifier generation method includes the following operations.

An operation 101 includes: obtaining an identifier.

In some embodiments of the present disclosure, a semantic identifier generation apparatus may obtain an identifier.

It should be noted that, in some embodiments of the present disclosure, the identifier obtained by the semantic identifier generation apparatus may be an original identifier of an IoT object, and the original identifier may also be referred to as a legacy identifier. For example, the legacy identifier may be an identifier sequence represented by a two-dimensional code label on the surface of a commodity. The present disclosure does not limit the type of the obtained identifier.

An operation 102 includes: determining an identification framework code of the identifier.

In some embodiments of the present disclosure, after obtaining the identifier, the semantic identifier generation apparatus may determine the identification framework code of the identifier.

It should be noted that, in some embodiments of the present disclosure, during determining the identification framework code of the identifier, the semantic identifier generation apparatus may determine a first image corresponding to the identifier, input the first image into a convolutional neural network, and obtain the identification framework code. The first image is a colored polygonal image.

In some embodiments of the present disclosure, during determining the first image corresponding to the identifier, the semantic identifier generation apparatus may determine a character array of the identifier, determine a code value of each character in the character array, and determine the first image based on a first code value of i-th character and a second code value of (i+1)-th character. i is a positive integer.

It should be noted that, in some embodiments of the present disclosure, the code value may be an American standard code for information interchange (ASCII) code. The present disclosure does not limit the type of the code value.

For example, in some embodiments of the present disclosure, assume that the identifier obtained by the semantic identifier generation apparatus is 6254687914710. The character array of the identifier may be determined as [6,2,5,4,6,8,7,9,1,4,7,1,0], and then the ASCII code of the characters in the character array may be determined as [54,50,53,52,54,56,49,57,49,52,55,49,48], so that the first image may be determined based on the ASCII code corresponding to the i-th character and the ASCII code corresponding to the (i+1)-th character.

It should be noted that, in some embodiments of the present disclosure, FIG. 2 is a schematic diagram of character mapping according to some embodiments of the present disclosure. As shown in FIG. 2, before determining the first image based on the ASCII code corresponding to the i-th character and the ASCII code corresponding to the (i+1)-th character, a circle may be equally divide into N parts with a radius of 128 (the value range of ASCII codes is 0 to 127), where N is the number of characters in the character array, and then each character in the character array of the identifier may be mapped to a point on an equally divided line in a counterclockwise order, where the distance between the position of the point and the center of the circle is the value of the ASCII code corresponding to the mapped character.

In some embodiments of the present disclosure, during determining the first image based on the first code value of the i-th character and the second code value of the (i+1)-th character, the semantic identifier generation apparatus may respectively determine a first color value and a second color value based on the first code value and the second code value, determine a RGB color value of a triangular region based on the first color value, the second color value, and a third color value, perform coloring processing based on the RGB color value, and obtain the first image. The triangular region is formed by positions corresponding to the i-th character, the (i+1)-th character, and the third color value;

It should be noted that, in some embodiments of the present disclosure, in RGB, R represents red, G represents green, and B represents blue. The color information corresponding to the first color value is green (G), the color information corresponding to the second color value is blue (B), and the color information corresponding to the third color value is red (R).

It should be noted that, in some embodiments of the present disclosure, the position corresponding to the third color value may be the origin of the circle.

For example, in some embodiments of the present disclosure, assume that i is 1. The first code value of the first character, i.e., the ASCII code value of the first character, is 54, and the ASCII code value of the (i+1)-th character, i.e, the ASCII code value of the second character, is 50. The ASCII code value of the first character and the ASCII code value of the second character may be respectively mapped to the RGB color space, so that the corresponding first color value and second color value may be determined. The first color value may be expressed by formula (1), the second color value may be expressed by formula (2), and the third color value is the color value corresponding to the origin. The third color value may be set to a constant value 255. Thus, the RGB color value of the triangular region may be determined as (255, 2*a1-1, 2*a2-1) based on the first color value, the second color value, and the third color value.

First color value=2*a1−1 (1)
a1 represents the ASCII code value of the i-th character.

Second color value=2*a2−1 (2)
a2 represents the ASCII code value of the (i+1)-th character.

It should be noted that, in some embodiments of the present disclosure, FIG. 3 is a schematic diagram of obtaining a first image according to some embodiments of the present disclosure. As shown in FIG. 3, the semantic identifier generation apparatus may traverse all adjacent vertices in the circle, i.e., the semantic identifier generation apparatus may determine the RGB color value of each triangular region based on the ASCII code value of the i-th character, the ASCII code value of the (i+1)-th character, and the third color value, connect all the mapped points, perform coloring (filling) processing on each triangular region inside the connected polygon with corresponding RGB color, and obtain the first image.

Further, in some embodiments of the present disclosure, the semantic identifier generation apparatus may input the generated first image into a convolutional neural network (CNN), thereby obtaining the identification framework code.

That is, in some embodiments of the present disclosure, the semantic identifier generation apparatus may automatically convert the identifier into a colored polygonal image, and then use the CNN to process the colored image to obtain the identification framework code of the identifier. The present disclosure can utilize the advantages of the CNN in processing colored images to improve the recognition accuracy of the identification.

An operation 103 includes: parsing the identifier based on the identification framework code and obtaining an ontology prefix code.

In some embodiments of the present disclosure, after determining the identification framework code of the identifier, the semantic identifier generation apparatus may parse the identifier based on the identification framework code and obtain the ontology prefix code.

It should be noted that, in some embodiments of the present disclosure, during parsing the identifier based on the identification framework code and obtaining the ontology prefix code, the semantic identifier generation apparatus may parse out an object category represented by the identifier based on the identification framework code, map the object category to a class in an ontology, and obtain the ontology prefix code.

It should be noted that, in some embodiments of the present disclosure, the ontology may be a set of terms used to describe a field, and the organizational structure may be a hierarchical structure. The present disclosure does not limit the number and types of classes included in the ontology.

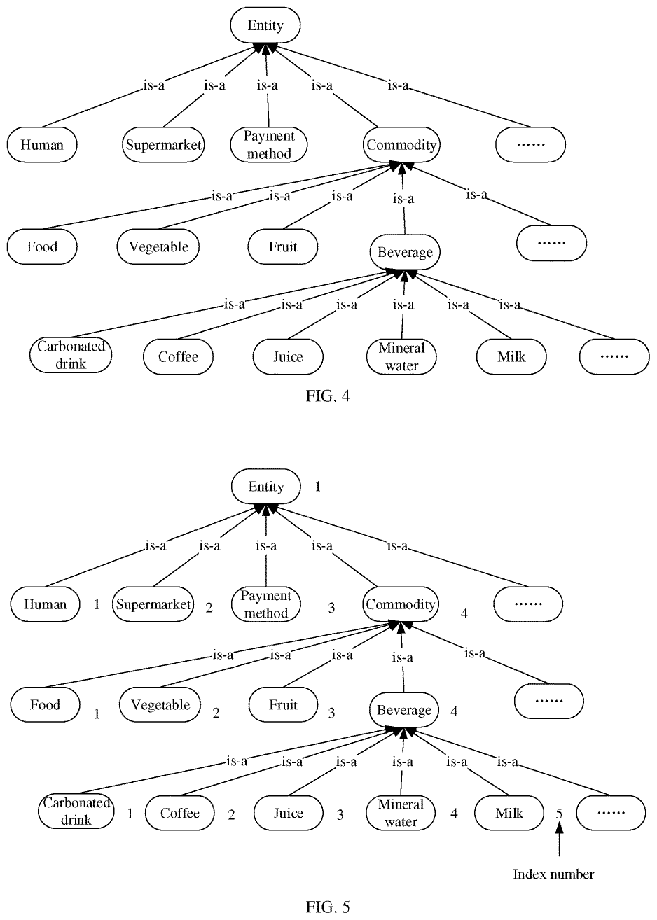

For example, in some embodiments of the present disclosure, FIG. 4 is a structural schematic diagram of an ontology according to some embodiments of the present disclosure. As shown in FIG. 4, the ontology may include an entity. The classes included in the entity are human, supermarket, payment method, and commodity, . . . , and different classes may further include different subclasses. For example, commodity includes the following subclasses: food, vegetable, fruit, and beverage, . . . . The present disclosure does not limit the number and types of classes included in the ontology.

It should be noted that, in some embodiments of the present disclosure, the semantic identifier generation apparatus may determine, based on the identification framework code, descriptive information represented by the identifier, and determine, based on the object category, the class of the object category in the ontology. The descriptive information may include at least one key-value pair, and the key at least include an object category, an object name, a retail price, or an object specification;

For example, in some embodiments of the present disclosure, as shown in Table 1 below, the descriptive information includes at least one key-value pair. The key may include a code (code), an article name (object name), an article category (object category), a specification (object specification), enterprise name, retail price, . . . , and the values corresponding to the keys are 8938515483013, Nestle coffee, coffee, 268 ml, Nestle (China) Co., Ltd., 10 yuan, . . . . The present disclosure does not limit the number and types of parameters included in the descriptive information.

TABLE 1

| key | value |
|---|---|
| code | 8938515483013 |
| article name | Nestle Coffee |
| article category | Coffee |
| specification | 268 ml |
| enterprise name | Nestle (China) Co., Ltd |
| retail price | 10 yuan |
| . . . | . . . |

Further, in some embodiments of the present disclosure, during determining the class of the object category in the ontology based on the object category, the semantic identifier generation apparatus may first a determine a semantic similarity between the object category and each class in the ontology, and determine, based on the semantic similarity, the class of the object category in the ontology.

For example, in some embodiments of the present disclosure, during determining the semantic similarity between the object category and each class in the ontology, the semantic identifier generation apparatus may determine the semantic similarity between the value of the object category and each class in the ontology. For example, as shown in Table 1 above, the semantic similarity between the object category and the words in the first column of keys in Table 1 may be calculated based on semantic similarity. The value corresponding to the key having the largest semantic similarity value is “coffee”, the semantic similarity between “coffee” and each class in the ontology may be calculated based on semantic similarity. The class in the ontology having the largest semantic similarity is the mapped class.

It should be noted that, in some embodiments of the present disclosure, after mapping the object category to the class in the ontology, the semantic identifier generation apparatus may determine, based on the class in the ontology, path information from a root node in the ontology to the class, and determine the ontology prefix code based on a first preset symbol and the path information. The path information may include a set of index numbers, and the index numbers are positive integers

For example, in some embodiments of the present disclosure, FIG. 5 is a structural schematic diagram of an ontology according to some embodiments of the present disclosure. As shown in FIG. 5, the classes included in an entity are human, supermarket, payment method, commodity . . . , and the corresponding index numbers are 1, 2, 3, 4, respectively. Commodity includes the following subclasses: food, vegetable, fruit, beverage, . . . , and the corresponding index numbers are 1, 2, 3, 4, respectively. Beverage includes the following subclasses: carbonated drink, coffee, juice, mineral water, milk, . . . , and the corresponding index numbers are 1, 2, 3, 4, 5, respectively.

It should be noted that, in some embodiments of the present disclosure, assume that the semantic identifier generation apparatus calculates, based on the semantic similarity, the semantic similarity between “coffee” and each class in the ontology, and the class in the ontology having the largest semantic similarity is coffee. The path information from the root node (entity) in the ontology to the class (coffee) may be determined based on the class (coffee) in the ontology. The path information from entity to coffee in the ontology may be represented by a set of index numbers. As shown in FIG. 5 above, the index number 1442 is the path information from entity to coffee in the ontology.

In some embodiments of the present disclosure, during determining the ontology prefix code based on the first preset symbol and the path information, the semantic identifier generation apparatus may perform separation processing on the index numbers via the first preset symbol, and obtain the ontology prefix code.

It should be noted that, in some embodiments of the present disclosure, the first preset symbol may be “.”. For example, the index number 1442 may be separated via the first preset symbol to obtain the ontology prefix code 1.4.4.2. The present disclosure does not limit the type of the first preset symbol.

It should be noted that, in some embodiments of the present disclosure, the object category may be automatically mapped to the class in the ontology via the semantic similarity technology, thereby automatically obtaining the ontology prefix code. This process does not require human participation, thus improving the intelligence of the IoT system.

It should be noted that, in some embodiments of the present disclosure, the semantic identifier generation apparatus may convert the obtained descriptive information (key-value pair) into data properties of the IoT ontology. For example, the descriptive information such as <retail price, 10 yuan> and <specification, 268 ml> of Nestle coffee is updated into the ontology. In this way, more details about the object may be obtained from the ontology without frequently accessing the legacy identifier management system. In addition, this information may serve as common knowledge to assist intelligent interaction between article objects.

An operation 104 includes: determining a semantic identifier based on the ontology prefix code, the identification framework code, and the identifier.

In some embodiments of the present disclosure, after parsing the identifier based on the identification framework code and obtain the ontology prefix code, the semantic identifier generation apparatus may determine the semantic identifier based on the ontology prefix code, the identification framework code, and the identifier.

It should be noted that, in some embodiments of the present disclosure, during determining the semantic identifier based on the ontology prefix code, the identification framework code, and the identifier, the semantic identifier generation apparatus may determine the semantic identifier based on a second preset symbol, the ontology prefix code, the identification framework code, and the identifier.

For example, in some embodiments of the present disclosure, the semantic identifier generation apparatus may combine the ontology prefix code, the identification framework code, and the identifier, and each part may be separated by the second preset symbol. The second preset symbol may be “/”. For example, 1.4.4.2 represents the ontology prefix code, 4 represents the identification framework code, and 8938515483013 represents the identifier. The semantic identifier may be represented as 1.4.4.2/4/8938515483013. The present disclosure does not limit the type of the second preset symbol.

In summary, the semantic identifier generation apparatus may automatically convert the identifier into a colored polygonal image, use the CNN to process the colored image to obtain the identification framework code of the identifier. The present disclosure may utilize the advantages of the CNN in processing colored images to improve the recognition accuracy of the identification. Then, the identifier may be parsed based on the identification framework code to obtain the ontology prefix code, i.e., the object category may be automatically mapped to the class in the ontology via the semantic similarity technology, thereby automatically obtaining the ontology prefix code. This process does not require human participation, thus improving the intelligence of the IoT system. Further, the semantic identifier may be determined based on the second preset symbol, the ontology prefix code, the identification framework code, and the identifier. The semantic identifier generation apparatus may convert the obtained descriptive information (key-value pair) into data properties of the IoT ontology. For example, the descriptive information such as <retail price, 10 yuan> and <specification, 268 ml> of Nestle coffee is updated into the ontology. In this way, more details about the object may be obtained from the ontology without frequently accessing the legacy identifier management system, and this information may serve as common knowledge to assist intelligent interaction between article objects.

The embodiments of the present disclosure provide a semantic identifier generation method. The method includes: a semantic identifier generation apparatus obtaining an identifier; determining an identification framework code of the identifier; parsing the identifier based on the identification framework code and obtaining an ontology prefix code; and determining a semantic identifier based on the ontology prefix code, the identification framework code, and the identifier. That is, the semantic identifier generation apparatus may automatically obtain the identification framework code of the identifier, then parse the identifier based on the identification framework code and obtain the ontology prefix code, and further determine the semantic identifier based on the ontology prefix code, the identification framework code, and the identifier. The entire process of generating the semantic identifier in the present disclosure does not require human participation, and the semantic identifier may be automatically generated, thereby improving the intelligence of the IoT system. Moreover, the ontology prefix code in the present disclosure may provide corresponding semantic information to support intelligent interaction between different objects.

### Embodiment 2

Based on the above embodiments, some embodiments of the present disclosure provide a semantic identifier generation method and a novel semantic compatible identification framework. The framework includes three parts: an ontology prefix (ontology prefix code), an original identification framework code (identification framework code), and an original identification (identifier), which may be accurately and uniquely compatible with a legacy identification to identify an IoT object, and may provide semantic information based on the ontology to support interaction between identified objects. Then, an automatic recognition method for a heterogeneous identification framework of a colored image is configured to obtain the identification framework code. Next, based on the semantic similarity technology, a method for automatically obtaining an ontology prefix is provided. Via mapping the object content (object category) parsed from the identification to the class in the ontology, the ontology prefix is automatically obtained. Finally, the ontology prefix (ontology prefix code), the original identification framework code (identification framework code), and the original identification (identifier) are combined, thereby automatically obtaining a semantic compatible identification (semantic identifier). The whole process does not require human participation. Based on the automatically generated semantic compatible identification (semantic identifier) and the common knowledge provided by the IoT ontology, intelligent interaction between IoT objects in IoT scenarios such as smart homes and unmanned supermarkets may be supported.

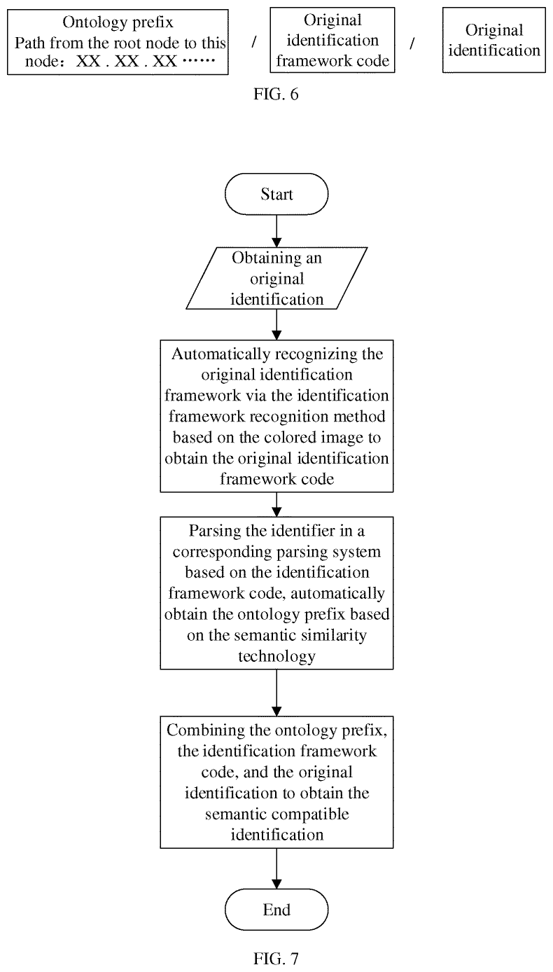

It should be noted that, in some embodiments of the present disclosure, FIG. 6 is a structural schematic diagram of a semantic identifier according to some embodiments of the present disclosure. As shown in FIG. 6, the semantic compatible identification (semantic identifier) mainly includes three parts: an ontology prefix (ontology prefix code), an original identification framework code (identification framework code), and an original identification (identifier). These three parts are connected by the symbol “/”. To construct the semantic compatible identification, some embodiments of the present disclosure designs an IoT ontology (ontology) and encodes the classes in each layer of the ontology from left to right, and the codes are referred to as class label codes (index numbers). The IoT ontology is shown in FIG. 5, which only shows a part of the ontology related to an unmanned supermarket.

It should be noted that, in some embodiments of the present disclosure, the identifier obtained by the semantic identifier generation apparatus may be an original identifier of an IoT object, and the original identifier may also be referred to as a legacy identifier. For example, the legacy identifier may be an identifier sequence represented by a two-dimensional code label on the surface of a commodity. The present disclosure does not limit the type of the obtained identifier.

It should be noted that, in some embodiments of the present disclosure, the ontology prefix (ontology prefix code) may include a set of integers separated by “.”, representing a path from the root node of the ontology to the class node of the identified object. In the ontology prefix, a parent node represents a parent class, and each integer segment from left to right represents a subclass label code (subclass index number) of the parent class. For example, the prefix “1.4” represents that the class is “commodity”, and the prefix “1.4.4” represents that the class is “beverage”, which is the fourth subclass of the “commodity” class. Via the ontology prefix (ontology prefix code), the specific class to which the object belongs may be obtained, so that the object may know what it is and what other objects are. Each object is mapped to an instance of a specific class in the ontology via the ontology prefix, and the relationship between the object and other objects are established. By designing the ontology prefix as a path from the root node of the ontology to the class node of the identified object, the hierarchical information of the identified article may be more clearly identified, and the ontology prefix can uniquely correspond to one class in the IoT ontology, reducing the problem of information confusion in the semantic prefix part in the related art.

It should be noted that, in some embodiments of the present disclosure, the original identification framework code (identification framework code) is an identification framework index number formulated by experts, as shown in Table 2 below, indicating which framework the original identifier (identifier) belongs to, and is configured to be compatible with heterogeneous identifications, so that a corresponding identifier parsing system may be selected to perform unified parsing based on the framework code of the original identification (identifier). When an identification is obtained, the framework code of the identification is required to be recognized first before subsequent unified parsing may be performed. Therefore, some embodiments of the present disclosure provide an identification framework recognition method based on a colored image.

TABLE 2

| Original identification | Framework to which original |
|---|---|
| framework code | identification belongs |
| 1 | Passport No |
| 2 | GLN |
| 3 | Credit card No |
| 4 | EAN-13 |
| 5 | EAN-8 |
| 6 | Licence |
| . . . | . . . |

It should be noted that, in some embodiments of the present disclosure, via the semantic compatible identification (semantic identifier), heterogeneous identifications in the IoT may be compatible. Via to the ontology prefix in the semantic compatible identification, all objects with heterogeneous identifications in the IoT system may be mapped to instances of corresponding classes in the IoT ontology, and each instance name is the semantic compatible identification. Therefore, IoT objects can use the common knowledge provided by the IoT ontology to perform intelligent collaboration tasks such as semantic retrieval and semantic reasoning. As shown in FIG. 5, the four categories of objects (human, supermarket, commodity, and payment method) in the IoT ontology respectively have different identifications. A commodity (coffee) is identified by a European article number (EAN) code, a human is identified by a passport number, a supermarket is identified by a global location number (GLN) of a participating party, and a payment method is identified by a credit card number. The semantic compatible identification (semantic identifier) adds different ontology prefixes (ontology prefix codes) and identification framework codes to the original identifications. Via the ontology prefix, the corresponding class of the identified object can be found in the ontology, and via the identification framework code, the framework to which the original identification belongs can be known. For example, “1.1/1/E501129487” represents that the object is a human, and the original identification framework is Passport No (passport number). Based on the semantic knowledge provided by the IoT ontology (unmanned supermarket part) as shown in FIG. 5, intelligent scenarios such as automatic shopping and automatic return in an unmanned supermarket can be supported.

In some embodiments of the present disclosure, the automatic generation process of the semantic compatible identification (semantic identifier) mainly includes three parts: automatic recognition of the identification framework (identification framework code), automatic acquisition of the ontology prefix (ontology prefix code), and automatic combination of the identification. In the automatic generation method of the semantic compatible identification (semantic identifier), no human participation is required, and the original identification can be intelligently and efficiently mapped as the semantic compatible identification, thereby compatible with the heterogeneous identification and providing semantic information understandable by IoT objects for the original identification, supporting intelligent interaction between IoT objects based on the semantic information in the ontology.

It should be noted that, in some embodiments of the present disclosure, FIG. 7 is a schematic diagram of the semantic identifier generation method according to some embodiments of the present disclosure. As shown in FIG. 7, the semantic identifier generation apparatus may first obtain an original identification (identifier), then automatically recognize the original identification framework via the identification framework recognition method based on the colored image to obtain the original identification framework code (identification framework code), then parse the identifier in a corresponding parsing system based on the identification framework code, automatically obtain the ontology prefix (ontology prefix code) based on the semantic similarity technology, and finally combine the ontology prefix (ontology prefix code), the identification framework code, and the original identification (identifier) to obtain the semantic compatible identification (semantic identifier).

It should be noted that, in some embodiments of the present disclosure, the present disclosure provides a method for automatically recognizing a heterogeneous identification framework based on a colored image to obtain an identification framework code. The deep learning technology has achieved remarkable success in the field of computer vision, especially the representative deep learning algorithm convolutional neural network (CNN), which performs better than humans in various image recognition tasks such as article detection, face recognition, image segmentation, and human pose estimation, etc. CNN is good at representing two-dimensional signals. With sufficient image samples and corresponding class labels, CNN can automatically adaptively extract hierarchical spatial features and color features, and learn a classifier. However, the CNN model requires inputting images, and performs better on colored images. Therefore, to meet the input requirements of the CNN, the present disclosure designs a conversion strategy from an identification to a colored image. The strategy flow is as follows. Compared with other image conversion strategies, this strategy can express more information, such as an identification length, a character size, and an identifier differential information, etc. Moreover, this strategy can more fully utilize the advantages of CNN in learning colored images, resulting in high identification recognition accuracy. In addition, compared with comprehensive identification methods in the related art, the present solution is simpler, more practical, and more scalable.

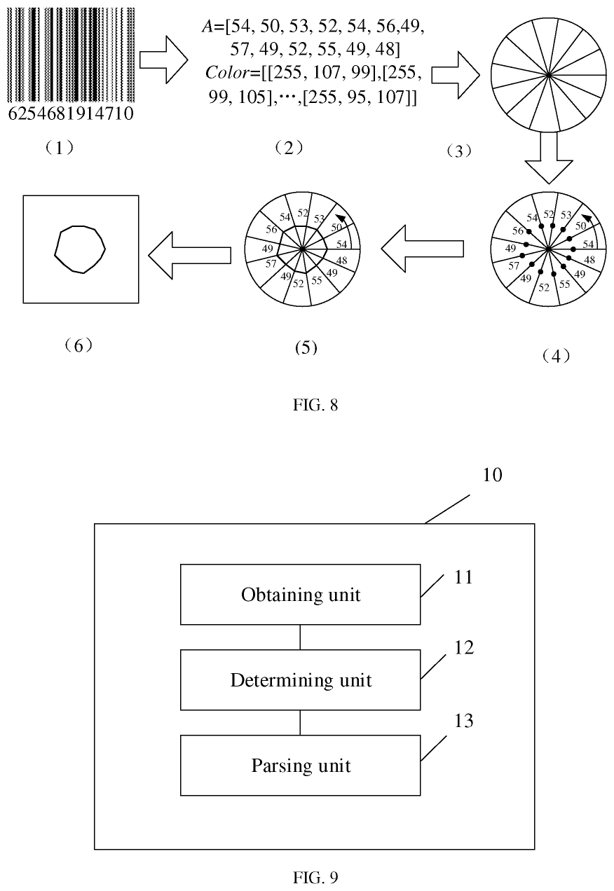

It should be noted that, in some embodiments of the present disclosure, FIG. 8 is a schematic diagram of a conversion strategy from an identification to a color image according to some embodiments of the present disclosure. As shown in FIG. 8, the conversion strategy may include the following operations. (1) Obtaining an identification string is obtained and converted into a character sequence (character array) with a length of n. (2) Each character of the identification character sequence (character array) is converted into an ASCII code to obtain an integer sequence [54,50,53,52,54,56,49,57,49,52,55,49,48] of length n. (3) A circle is made with a radius of 128 (the value range of ASCII codes is 0 to 127) and equally divided into n parts. (4) Each character of the identification mapped as a point in order on an equally divided line in the circle of operation (3), the distance between the position of each point and the center of the circle is equal to a ASCII code value corresponding to a mapped identification position (mapped character), the first character is mapped to the 0° equally divided line, and the following characters are mapped to the corresponding equally divided lines in a counterclockwise order. (5) In addition, based on the ASCII code values corresponding to adjacent vertex i (the i-th character) and i+1 (the (i+1)-th character), the triangular region formed by the adjacent vertices i and i+1 and the center of the circle colored in RGB color; in a case where the ASCII code values corresponding to the adjacent vertices i and i+1 respectively are a1 and a2, the RGB color value is (255, 2*a1-1, 2*a2-1). (6) All the mapped points are connected, and coloring is performed based on the RGB colors of the corresponding triangular regions to obtain a colored polygonal image, and the colored image is saved.

For example, in some embodiments of the present disclosure, assume that the identifier obtained by the semantic identifier generation apparatus is 6254687914710. The character array of the identifier may be determined as [6,2,5,4,6,8,7,9,1,4,7,1,0], and the ASCII codes of all character in the character array may be determined as [54,50,53,52,54,56,49,57,49,52,55,49,48], so that the first image (colored polygonal image) may be determined based on the ASCII code corresponding to the i-th character and the ASCII code corresponding to the (i+1)-th character.

For example, in some embodiments of the present disclosure, assume that i is 1. The first code value of the first character, i.e., the ASCII code value of the first character, is 54, and the ASCII code value of the (i+1)-th character, i.e, the ASCII code value of the second character, is 50. The corresponding first color value and second color value may be respectively determined based on the ASCII code value of the first character and the ASCII code value of the second character. The first color value may be expressed by the above formula (1), the second color value may be expressed by the above formula (2), and the third color value is the color value corresponding to the origin. The third color value may be set to a constant value 255. Thus, the RGB color value of the triangular region may be determined as (255, 2*a1-1, 2*a2-1) based on the first color value, the second color value, and the third color value.

It should be noted that, in some embodiments of the present disclosure, the semantic identifier generation apparatus may traverse all adjacent vertices in the circle. That is, the semantic identifier generation apparatus may determine the RGB color value of each triangular region based on the ASCII code value of the i-th character, the ASCII code value of the (i+1)-th character, and the third color value, connect all the mapped points, and perform coloring processing based on the RGB color value, thereby obtaining the first image.

It should be noted that, in some embodiments of the present disclosure, the identification framework code is obtained by corresponding the identification framework recognized by the above method to the identification framework index table (as shown in Table 2) established by experts. For example, the identification E501129487 is recognized as Passport No (passport number) by the identification recognition algorithm, and based on the identification framework index table established by experts, it can be known that the identification framework code is 1.

That is, in some embodiments of the present disclosure, the semantic identifier generation apparatus may automatically convert the identifier into a colored polygonal image, and then use the CNN to process the colored image to obtain the identification framework code of the identifier. The present disclosure can utilize the advantages of the CNN in processing colored images to improve the recognition accuracy of the identification.

In some embodiments of the present disclosure, after an enterprise or a user produces a commodity, he will perform code registration and descriptive information filling on identification parsing platforms such as the Handle, the Ecode, and the OID. For example, for the article “Nestle coffee”, the descriptive information will be filled in during registration. As shown in Table 1, the information in the table appears in the form of key-value pair, the first column is the key, and the second column is the value corresponding to the key, such as <article category, coffee>.

For example, in some embodiments of the present disclosure, as shown in Table 1 above, the descriptive information may include at least one key-value pair. The keys may include code, article name (object name), article category (object category), specification (object specification), enterprise name, retail price, . . . , and the values corresponding to the keys are 8938515483013, Nestle coffee, coffee, 268 ml, Nestle (China) Co., Ltd., 10 yuan, . . . , respectively. The present disclosure does not limit the number and types of parameters included in the descriptive information.

It should be noted that, in some embodiments of the present disclosure, because different enterprises or users have different cognitions or experiences, when registering IoT articles, they use different descriptive information to describe the IoT articles. Different identification systems may use different information templates to describe IoT articles. In addition, the words used in the IoT ontology may be different from the words used in the descriptive information in the identification parsing system, synonyms of other situations may exist. For example, user 1 uses “article type, coffee” to describe an object, and user 2 uses “article category, coffee” to describe the object. Therefore, it is difficult for a legacy identification to be directly mapped to the ontology to obtain the ontology prefix. A method is required to be designed to achieve automatic acquisition of the ontology prefix. The present disclosure provides a method for automatically obtaining an ontology prefix (ontology prefix code) based on a semantic similarity technology. The flow is as follows. (1) First, the semantic identifier generation apparatus may obtain the identification framework and parse it. Based on the identification framework obtained in the first operation, a parsing request is sent to a parsing system associated with the identification framework to obtain a descriptive information table of the identified object filled in by the user, as shown in Table 1. (2) The semantic identifier generation apparatus may obtain the category of the article based on semantic similarity technology, train a Word2vec model based on a large-scale corpus such as Wikipedia, then calculate, based on the semantic similarity technology, the semantic similarity between the words in the first column of keys in the identification descriptive information table and the word of article category (object category), obtain the value corresponding to the key having the largest semantic similarity value. The value is the class of the IoT article. As shown in Table 1, the key having the largest semantic similarity with the article category is the key “article category” in the second row, and the corresponding value is “coffee”. (3) The ontology class (the class of the object category in the ontology) is obtained via mapping the obtained article category (object category) to the ontology, the semantic similarity between the value corresponding to the article category in the identified descriptive information and each class in the IoT ontology is calculated again based on the semantic similarity technology, and the class in the IoT ontology having the largest semantic similarity is the mapped class. (4) The semantic prefix (ontology prefix code) is obtained based the ontology class, so that the path (path information) from the root node to the class is obtained based on the position of the mapped class in the IoT ontology, and each layer of the path is separated by “.”, thereby obtaining the ontology prefix (ontology prefix code). For example, “coffee” has the largest semantic similarity with “coffee” in the IoT ontology, so that the identified object is mapped to “coffee” in the IoT ontology, and therefore the semantic prefix (ontology prefix code) is 1.4.4.2.

For example, in some embodiments of the present disclosure, during determining the semantic similarity between the object category and each class in the ontology, the semantic identifier generation apparatus may determine the semantic similarity between the value of the object category and each class in the ontology. For example, as shown in Table 1 above, the semantic similarity between the object category and the words in the first column of keys in Table 1 may be calculated based on semantic similarity. The value corresponding to the key having the largest semantic similarity value is “coffee”. Then, the semantic similarity between “coffee” and each class in the ontology may be calculated based on semantic similarity. The class in the ontology having the largest semantic similarity is the mapped class.

It should be noted that, in some embodiments of the present disclosure, after mapping the object category to the class in the ontology, the semantic identifier generation apparatus may determine, based on the class in the ontology, path information from a root node in the ontology to the class, and determine the ontology prefix code based on a first preset symbol and the path information. The path information includes a set of index numbers, and the index numbers are positive integers.

For example, in some embodiments of the present disclosure, as shown in FIG. 5, the classes included in an entity are human, supermarket, payment method, commodity . . . , and the corresponding index numbers are 1, 2, 3, 4, respectively. Commodity includes the following subclasses: food, vegetable, fruit, beverage, . . . , and the corresponding index numbers are 1, 2, 3, 4, respectively. Beverage includes the following subclasses: carbonated drink, coffee, juice, mineral water, milk, . . . and the corresponding index numbers are 1, 2, 3, 4, 5, respectively.

It should be noted that, in some embodiments of the present disclosure, assume that the semantic identifier generation apparatus calculates, based on the semantic similarity, the semantic similarity between “coffee” and each class in the ontology, and the class in the ontology having the largest semantic similarity is coffee. The path information from the root node (entity) in the ontology to the class (coffee) may be determined based on the class (coffee) in the ontology. The path information from entity to coffee in the ontology may be represented by a set of index numbers. As shown in FIG. 5 above, the index number 1442 is the path information from entity to coffee in the ontology.

For example, in some embodiments of the present disclosure, the first preset symbol may be “.”. For example, the index number 1442 may be separated via the first preset symbol to obtain the ontology prefix code 1.4.4.2. The present disclosure does not limit the type of the first preset symbol.

It should be noted that, in some embodiments of the present disclosure, the object category may be automatically mapped to the class in the ontology via the semantic similarity technology, thereby automatically obtaining the ontology prefix code. This process does not require human participation, thus improving the intelligence of the IoT system.

It should be noted that, in some embodiments of the present disclosure, the semantic identifier generation apparatus may convert the obtained descriptive information (key-value pair) into data properties of the IoT ontology. For example, the descriptive information such as <retail price, 10 yuan> and <specification, 268 ml> of Nestle coffee is updated into the ontology. In this way, more details about the object may be obtained from the ontology without frequently accessing the legacy identifier management system. In addition, this information may serve as common knowledge to assist intelligent interaction between article objects.

In some embodiments of the present disclosure, the semantic identifier generation apparatus may combine the ontology prefix (ontology prefix code), the semantic identification framework code (identification framework code), and the original identification (identifier), with each part separated by “/” (second preset symbol), to finally obtain the semantic identification (semantic identifier). For example, “1.1/1/E501129487” represents that the object is a human, and “1.4.4.2/4/8938515483013” represents a commodity coffee.

It should be noted that, in some embodiments of the present disclosure, based on the above automatic generation process of the semantic compatible identification (semantic identifier), a wide variety of heterogeneous identifications can be compatible. In addition, the semantic compatible identification (semantic identifier) embeds semantic information into the character sequence, so that each recognized object becomes an instance of the semantic ontology. In the IoT ontology, a set of commonly used classes and properties are defined, and each instance belonging to a class is named with the semantic identifier. In this way, the ontology, as a knowledge base, can provide common knowledge for objects identified by the semantic compatible identification, achieving autonomous collaborative decision-making.

In summary, the semantic identifier generation apparatus may automatically convert the identifier into a colored polygonal image, use the CNN to process the colored image to obtain the identification framework code of the identifier. The present disclosure may utilize the advantages of the CNN in processing colored images to improve the recognition accuracy of the identification. Then, the identifier may be parsed based on the identification framework code to obtain the ontology prefix code, i.e., the object category may be automatically mapped to the class in the ontology via the semantic similarity technology, thereby automatically obtaining the ontology prefix code. This process does not require human participation, thus improving the intelligence of the IoT system. Further, the semantic identifier may be determined based on the second preset symbol, the ontology prefix code, the identification framework code, and the identifier. The semantic identifier generation apparatus may convert the obtained descriptive information (key-value pair) into data properties of the IoT ontology. For example, the descriptive information such as <retail price, 10 yuan> and <specification, 268 ml> of Nestle coffee is updated into the ontology. In this way, more details about the object may be obtained from the ontology without frequently accessing the legacy identifier management system, and this information may serve as common knowledge to assist intelligent interaction between article objects.

The embodiments of the present disclosure provide a semantic identifier generation method. The method includes: a semantic identifier generation apparatus obtaining an identifier; determining an identification framework code of the identifier; parsing the identifier based on the identification framework code and obtaining an ontology prefix code; and determining a semantic identifier based on the ontology prefix code, the identification framework code, and the identifier. That is, the semantic identifier generation apparatus may automatically obtain the identification framework code of the identifier, then parse the identifier based on the identification framework code and obtain the ontology prefix code, and further determine the semantic identifier based on the ontology prefix code, the identification framework code, and the identifier. The entire process of generating the semantic identifier in the present disclosure does not require human participation, and the semantic identifier may be automatically generated, thereby improving the intelligence of the IoT system. Moreover, the ontology prefix code in the present disclosure may provide corresponding semantic information to support intelligent interaction between different objects.

### Embodiment 3

Based on the above embodiments, some embodiments of the present disclosure provide a semantic identifier generation apparatus. FIG. 9 is a structural schematic diagram of a semantic identifier generation apparatus according to some embodiments of the present disclosure. As shown in FIG. 9, the semantic identifier generation apparatus 10 includes an obtaining unit 11, a determining unit 12, and a parsing unit 13.

The obtaining unit 11 is configured to obtain an identifier.

The determining unit 12 is configured to determine an identification framework code of the identifier.

The parsing unit 13 is configured to parse the identifier based on the identification framework code and obtain an ontology prefix code.

The determining unit 12 is configured to determine a semantic identifier based on the ontology prefix code, the identification framework code, and the identifier.

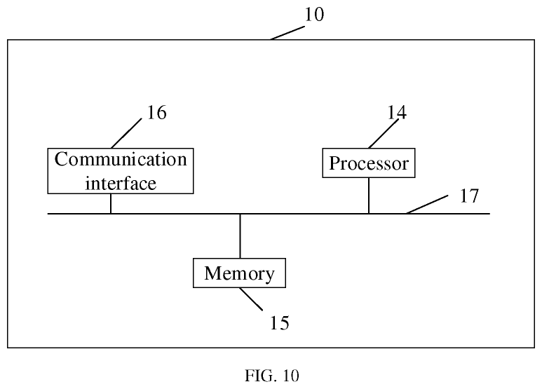

In the embodiments of the present disclosure, FIG. 10 is a structural schematic diagram of a semantic identifier generation apparatus according to some embodiments of the present disclosure. As shown in FIG. 10, the semantic identifier generation apparatus 10 according to some embodiments of the present disclosure includes a processor 14, a memory 15 storing instructions executable by the processor 14. In the embodiments, the semantic identifier generation apparatus 10 may include a communication interface 16, and a bus 17 configured to be connected to the processor 14, the memory 15, and the communication interface 16.

In some embodiments of the present disclosure, the processor 14 may be at least one of an application specific integrated circuit (ASIC), a digital signal processor (DSP), a digital signal processing device (DSPD), a programmable logic device (PLD), a field programmable gate array (FPGA), a central processing unit (CPU), a controller, a microcontroller, or a microprocessor. It is understandable that, for different devices, the electronic components for implementing the processor function may be other components, which are not limited in the embodiments of the present disclosure. The semantic identifier generation apparatus 10 may include a memory 15, and the memory 15 may be connected to the processor 14. The memory 15 is configured to store executable program code, which includes computer operation instructions. The memory 15 may include a high-speed RAM memory, and may include a non-transitory memory, such as at least two disk memories.

In some embodiments of the present disclosure, the bus 17 is configured to be connected to the communication interface 16, the processor 14, and the memory 15, and to enable mutual communication between these components.

In some embodiments of the present disclosure, the memory 15 is configured to store instructions and data.

In some embodiments of the present disclosure, the processor 14 is configured to: obtain an identifier; determine an identification framework code of the identifier; parse the identifier based on the identification framework code and obtain an ontology prefix code; and determine a semantic identifier based on the ontology prefix code, the identification framework code, and the identifier.

In practical applications, the memory 15 may be a transitory memory, such as a random-access memory (RAM); or a non-transitory memory, such as a read-only memory (ROM), a flash memory, a hard disk drive (HDD), or a solid-state drive (SSD); or a combination of the above types of memories. The memory 15 is configured to provide instructions and data to the processor 14.

Some embodiments of the present disclosure provide a semantic identifier generation apparatus. The semantic identifier generation apparatus is configured to: obtain an identifier; determine an identification framework code of the identifier; parse the identifier based on the identification framework code and obtain an ontology prefix code; and determine a semantic identifier based on the ontology prefix code, the identification framework code, and the identifier. That is, the semantic identifier generation apparatus may automatically obtain the identification framework code of the identifier, then parse the identifier based on the identification framework code and obtain the ontology prefix code, and further determine the semantic identifier based on the ontology prefix code, the identification framework code, and the identifier. The entire process of generating the semantic identifier in the present disclosure does not require human participation, and the semantic identifier may be automatically generated, thereby improving the intelligence of the IoT system. Moreover, the ontology prefix code in the present disclosure may provide corresponding semantic information to support intelligent interaction between different objects.

Some embodiments of the present disclosure provide a non-transitory computer-readable storage medium storing a program, and when the program is executed by a processor, the semantic identifier generation method as described above is implemented.

In some embodiments, the program instructions corresponding to the semantic identifier generation method in this embodiment may be stored on a storage medium such as an optical disk, a hard disk, or a USB flash drive, etc. When the program instructions corresponding to the semantic identifier generation method on the storage medium are read or executed by an electronic device, the following operations are performed:
obtaining an identifier;
determining an identification framework code of the identifier;
parsing the identifier based on the identification framework code and obtaining an ontology prefix code; and
determining a semantic identifier based on the ontology prefix code, the identification framework code, and the identifier.

It should be understood by those skilled in the art that the embodiments of the present disclosure may be provided as a method, a system, or a computer program product. Therefore, the present disclosure may take the form of a hardware embodiment, a software embodiment, or an embodiment combining software and hardware aspects. Moreover, the present disclosure may take the form of a computer program product implemented on one or more computer-usable storage media (including but not limited to disk storage and optical storage) that includes computer-usable program code therein.

The present disclosure is described with reference to implementation flow diagrams and/or block diagrams of the method, device (system), and computer program product according to the embodiments of the present disclosure. It should be understood that each flow and/or block in the implementation flow diagrams and/or block diagrams, and combinations of flows and/or blocks in the implementation flow diagrams and/or block diagrams, can be implemented by computer program instructions. These computer program instructions may be provided to a processor of a general-purpose computer, a special-purpose computer, an embedded processor, or another programmable data processing device to produce a machine, so that the instructions executed by the processor of the computer or the other programmable data processing device produce a device configured to implement the functions specified in one or more flows of the implementation flow diagrams and/or one or more blocks of the block diagrams.

These computer program instructions may be stored in a computer-readable memory that can guide a computer or another programmable data processing device to operate in a specific manner, so that the instructions stored in the computer-readable memory produce an article of manufacture including an instruction apparatus, and the instruction apparatus is configured to implement the functions specified in one or more flows of the implementation flow diagrams and/or one or more blocks of the block diagrams.

These computer program instructions may be loaded onto a computer or another programmable data processing device, so that a series of operations are performed on the computer or the other programmable device to produce computer-implemented processing, thereby the instructions executed on the computer or the other programmable device provide operations for implementing the functions specified in one or more flows of the implementation flow diagrams and/or one or more blocks of the block diagrams.

The above description is merely some embodiments of the present disclosure and is not intended to limit the scope of the present disclosure.

1. A semantic identifier generation method, comprising:
obtaining an identifier;
determining an identification framework code of the identifier;
parsing the identifier based on the identification framework code and obtaining an ontology prefix code; and
determining a semantic identifier based on the ontology prefix code, the identification framework code, and the identifier.

2. The method according to claim 1, wherein the determining the identification framework code of the identifier comprises:
determining a first image corresponding to the identifier; wherein the first image is a colored polygonal image; and
inputting the first image into a convolutional neural network and obtaining the identification framework code.

3. The method according to claim 2, wherein the determining the first image corresponding to the identifier comprises:
determining a character array of the identifier;
determining a code value of each character in the character array;
determining the first image based on a first code value of an i-th character and a second code value of an (i+1)-th character; wherein i is a positive integer.

4. The method according to claim 3, wherein the determining the first image based on the first code value of the i-th character and the second code value of the (i+1)-th character comprises:
determining a corresponding first color value and a corresponding second color value based on the first code value and the second code value respectively;
determining a RGB color value of a triangular region based on the first color value, the second color value, and a third color value; wherein the triangular region comprises a position corresponding to the i-th character, a position corresponding to the (i+1)-th character, and a position corresponding to the third color value; and
performing coloring processing based on the RGB color value and obtaining the first image.

5. The method according to claim 1, wherein the parsing the identifier based on the identification framework code and obtaining the ontology prefix code comprises:
parsing out an object category represented by the identifier based on the identification framework code; and
mapping the object category to a class in an ontology and obtaining the ontology prefix code.

6. The method according to claim 5, further comprising:
determining descriptive information represented by the identifier based on the identification framework code; wherein the descriptive information comprises at least one key-value pair which comprises a key and a value, and the key at least comprises an object category, an object name, a retail price, and an object specification; and
determining the class of the object category in the ontology based on the object category.

7. The method according to claim 6, wherein the determining the class of the object category in the ontology based on the object category comprises:
determining a semantic similarity between the object category and each class in the ontology; and
determining the class of the object category in the ontology based on the semantic similarity.

8. The method according to claim 5, wherein after the mapping the object category to the class in the ontology, the method further comprises:
determining path information from a root node in the ontology to the class based on the class in the ontology; wherein the path information comprises a set of index numbers, and the index numbers are positive integers; and
determining the ontology prefix code based on a first preset symbol and the path information.

9. The method according to claim 8, wherein the determining the ontology prefix code based on the first preset symbol and the path information comprises:
performing separation processing on the index numbers via the first preset symbol and obtaining the ontology prefix code.

10. The method according to claim 1, wherein the determining the semantic identifier based on the ontology prefix code, the identification framework code, and the identifier comprises:
determining the semantic identifier based on a second preset symbol, the ontology prefix code, the identification framework code, and the identifier.

11. A semantic identifier generation apparatus, comprising a processor and a memory; wherein
the memory is configured to store a computer program executable on the processor; and
the processor is configured to, when running the computer program, perform a semantic identifier generation method; wherein the method comprises:
obtaining an identifier;
determining an identification framework code of the identifier;
parsing the identifier based on the identification framework code and obtaining an ontology prefix code; and
determining a semantic identifier based on the ontology prefix code, the identification framework code, and the identifier.

12. The semantic identifier generation apparatus according to claim 11, wherein the determining the identification framework code of the identifier comprises:
determining a first image corresponding to the identifier; wherein the first image is a colored polygonal image; and
inputting the first image into a convolutional neural network and obtaining the identification framework code.

13. The semantic identifier generation apparatus according to claim 12, wherein the determining the first image corresponding to the identifier comprises:
determining a character array of the identifier;
determining a code value of each character in the character array;
determining the first image based on a first code value of an i-th character and a second code value of an (i+1)-th character; wherein i is a positive integer.

14. The semantic identifier generation apparatus according to claim 13, wherein the determining the first image based on the first code value of the i-th character and the second code value of the (i+1)-th character comprises:
determining a corresponding first color value and a corresponding second color value based on the first code value and the second code value respectively;
determining a RGB color value of a triangular region based on the first color value, the second color value, and a third color value; wherein the triangular region comprises a position corresponding to the i-th character, a position corresponding to the (i+1)-th character, and a position corresponding to the third color value; and
performing coloring processing based on the RGB color value and obtaining the first image.

15. The semantic identifier generation apparatus according to claim 11, wherein the parsing the identifier based on the identification framework code and obtaining the ontology prefix code comprises:
parsing out an object category represented by the identifier based on the identification framework code; and
mapping the object category to a class in an ontology and obtaining the ontology prefix code.

16. The semantic identifier generation apparatus according to claim 15, wherein the method further comprises:
determining descriptive information represented by the identifier based on the identification framework code; wherein the descriptive information comprises at least one key-value pair which comprises a key and a value, and the key at least comprises an object category, an object name, a retail price, and an object specification; and
determining the class of the object category in the ontology based on the object category.

17. The semantic identifier generation apparatus according to claim 16, wherein the determining the class of the object category in the ontology based on the object category comprises:
determining a semantic similarity between the object category and each class in the ontology; and
determining the class of the object category in the ontology based on the semantic similarity.

18. The semantic identifier generation apparatus according to claim 15, wherein after the mapping the object category to the class in the ontology, the method further comprises:
determining path information from a root node in the ontology to the class based on the class in the ontology; wherein the path information comprises a set of index numbers, and the index numbers are positive integers; and
determining the ontology prefix code based on a first preset symbol and the path information.

19. The semantic identifier generation apparatus according to claim 18, wherein the determining the ontology prefix code based on the first preset symbol and the path information comprises:
performing separation processing on the index numbers via the first preset symbol and obtaining the ontology prefix code.

20. A non-transitory computer-readable storage medium, storing a computer program code;
wherein the computer program code, when executed by a computer, implements a semantic identifier generation method; wherein the method comprises:
obtaining an identifier;
determining an identification framework code of the identifier;
parsing the identifier based on the identification framework code and obtaining an ontology prefix code; and
determining a semantic identifier based on the ontology prefix code, the identification framework code, and the identifier.
